(19) United States
(12) Patent Application Publication
(10) Pub. No.: US 2024/0005149 A1
(43) Pub. Date: Jan. 4, 2024

(54) MANAGEMENT OF PROCESSES WITH TEMPORAL DEVELOPMENT INTO THE PAST, IN PARTICULAR OF PROCESSES TAKING PLACE AT THE SAME TIME IN INDUSTRIAL INSTALLATIONS, WITH THE AID OF NEURAL NETWORKS

(71) Applicant: Siemens Aktiengesellschaft, München (DE)

(72) Inventors: Michel Tokic, Tettnang (DE); Anja von Beuningen, Erfurt (DE); Niklas Körwer, Köln (DE); Martin Bischoff, Aying (DE); David Grossenbacher, Prag 6-Dejvice (CZ); Michael Leipold, Nürnberg (DE)

(21) Appl. No.: 18/214,121

(22) Filed: Jun. 26, 2023

(30) Foreign Application Priority Data
Jun. 30, 2022 (EP) 22182422.0

(51) Int. Cl. G06N 3/08

(52) U.S. Cl. CPC G06N 3/08

(57) ABSTRACT

Using the example of a logistics system including a plurality of parallel conveyor lines for piece goods, which each lead to a combining unit in the conveying direction, it is provided how the temporally and spatially extremely complex control of such an industrial installation can be simulated with the aid of neural networks such that the temporal and spatial dependences are also reliably identified by the neural network. This is effected by digital stopwatches which are applied to the neural network in addition to sensor data from the logistics system and are reset to an initial value whenever motion detectors indicate the passage of a package.

### CROSS-REFERENCE TO RELATED APPLICATIONS

This application claims priority to EP application No. 22182422.0, having a filing date of Jun. 30, 2022, the entire contents of which are hereby incorporated by reference.

### FIELD OF TECHNOLOGY

The following relates to a management of processes with temporal development into the past, in particular of processes taking place at the same time in industrial installations, with the aid of neural networks.

### BACKGROUND

Neural networks are computer-implemented, artificial tools in the technical field of machine learning and artificial intelligence. The technical term “neural network” is understood by a relevant person skilled in the art in the field of digital technology as meaning an artificial network of computers (called “nodes” or “neurons”) which has a precisely defined form and structure. A computer-implemented, artificial neural network has input and output nodes and, depending on the configuration, inner nodes in between. The nodes are connected to one another in a clearly and unambiguously defined manner by so-called edges. Each node has a receiving side and a transmitting side. On the receiving side, values are received from upstream nodes and are correlated in the node on the basis of local weights, for example by multiplying each received value by a weight specific to this edge and possibly incrementing it by a predefined value and then adding together all values which have been weighted in this manner. If the resulting sum exceeds a specific value (for example defined by a so-called “activation function”), the node is activated, and the determined value is output on the transmitting side (for example to downstream nodes). A non-activated node outputs a zero or no value at all, for example.

During operation, input data are applied to the input nodes and are processed by the network as described above, which results in output data being output at the output nodes. This method of operation of a neural network is referred to as “prediction” or “inference”.

The local weights in the nodes are configured by so-called “training” or “learning”. In this case, the starting point of the learning process is randomly selected at the beginning by assigning random numbers to the weights since there is no knowledge of which combination of weights can be used by a neural network to solve a problem given to it. Some of the training data (for example 90%) are then input step by step to the neural network in succession and it is observed what the neural network outputs as the prediction. This step is referred to as “forward pass”. In this case, the training data pass forward through the network. In each step, the output of the network is compared with the desired result which should have been output by the network for the respective training data item. Subtraction is then used to determine how wrong the neural network was. The error calculated in this manner is now used to change the weights stored in the neural network, using a learning method called “backpropagation”, in such a manner that the result becomes slightly better. For this purpose, the error is divided among the nodes, starting from the output nodes, in the opposite direction, that is to say in the direction of the input nodes, along the structure of the neural network, as a result of which a node-specific desired result is formed for each node. These node-specific desired results are used to slightly increase or reduce the weights in the nodes. In this case, the weights are adjusted to a greater extent, the closer they were to the node-specific desired result. The learning process thereby determines which part of the network caused the most serious error and counteracts this in an accordingly weighted manner by readjusting the weights. This is the so-called “backward pass” because the error flows backward through the network from the output to the input. The next time, the network is then alongside to a somewhat lesser extent and the entire process is repeated. This must be done for quite a while: Several ten or hundred thousand times in the case of simple tasks, for example the recognition of images, and also several billion times in the case of difficult tasks, for example pedestrian recognition for a self-driving automobile. If the error is small enough for this training data item during training, the process proceeds to the next training data item and, if the error is small enough for all training data, training is stopped. Other sequences in the use of the training data and other abort criteria for the training are also possible.

The quality of the training is now checked using the remaining training data which have hitherto not been used for the training (for example 10%). The network has never seen these training data and therefore was not able to “memorize” them, that is to say store them in the weights by training.

If the network is able to provide the appropriate desired result in response to an acceptable amount of these training data, the training of the neural network was most likely successful. The training can be terminated, and the operation of the neural network can be started. In this case, the neural network can still be readjusted during operation by training (for example if users select the images in which certain requested items are seen, but the neural network has not detected the presence thereof).

However, if the network is not able to provide the appropriate desired result in response to an acceptable amount of these training data, one is faced with the usually extremely challenging technical problem of looking for the cause of this and/or solutions in which the network provides the appropriate desired result in response to an acceptable amount of these training data.

Describing the behavior of a complex neural network may be very challenging on account of its complexity and multi-dimensional structure. Terms borrowed from mathematics may be a well-functioning description tool for this purpose. For example, the state of a neural network at a particular time can be captured well using a state vector in which an entry is provided for each node. The sum of all learnt weights can meanwhile be represented well using matrices. The dynamic behavior of a neural network over time can then be described well by multiplying the state vector by the weight matrix.

Neural networks are—perhaps boosted by their good mathematical descriptiveness—occasionally considered to be an example of computing models and algorithms which are intended to be of an abstract mathematical nature per se. However, this point of view causes difficulties linguistically and factually. Linguistically, a network is a network, and a model is a model. One does not become the other simply because this is asserted or there is a desire to see it this way. Factually, a neural network for a relevant person skilled in the art in the field of digital technology is, in a manner linguistically matching the words, an artificial “network” of computer-implemented nodes, as described at the outset. Even though it may be tempting and perhaps even comprehensible, the use of mathematical description means must not result in neural networks being equated with mathematics simply because these networks can be described well using terms borrowed from mathematics.

This important distinction is also reflected in decision T 1924/17 of 07.29.2019 by the Board of Appeal 3.5.07 of the European Pat. Office, according to paragraph 19.1 of which mathematics and, in particular, mathematics “as such” can be understood only as meaning the following:
the abstract science of number, quantity, and space,
the deduction and provability of mathematical theorems starting from a set of mathematical axioms,
a game played according to certain simple rules with meaningless marks on paper.

Neural networks are therefore not mathematics. They instead form an independent technical field with technical problems specific to them and a multiplicity of possible technical solutions to these problems.

Like in any technical field, there is also the task here of identifying at least one technical problem and specifying at least one technical teaching for solving the problem.

This task is accomplished by the present document and here, in particular, by the following part of the description and the drawings. It is clear from the claims which technical teaching is protected here as embodiments of the invention.

Although neural networks can often be universally used as a separate technical field and are not restricted to a specific application, it may nevertheless serve for better comprehensibility if their specific problems and solutions are described on the basis of a specific application. In the present case, the management of processes with temporal development into the past, in particular of processes taking place at the same time in industrial installations—in particular industrial installations consisting of individually controllable conveyor belt sections—with the aid of neural networks is therefore described below. However, as stated, this is used only for better illustration and is not intended to be understood in any way as a restriction to this application.

Industrial installations consisting of individually controllable conveyor belt sections are often used in intra-logistics or generally in the production environment. For example, package sorting installations consist of one or more fingers which in turn comprise a plurality of conveyor belt sections connected in succession. Package sorting installations are used, inter alia, to separate packages of different or identical sizes. Another example is a packaging machine in which the products on a conveyor line need to be accelerated/decelerated in order to deliver the product to suit the clock frequency of a flow-wrapping machine at the end of the conveyor line.

In this case, a “dynamic gapper” is a controlled drive application used in intra-logistics. In this application, packages which are generally conveyed by two or more parallel conveyor lines in one direction are intended to be merged onto a single output conveyor line. In this case, the packages which are at undefined distances on the two or more parallel conveyor lines are intended to be sorted onto the output conveyor line by a combining unit and at the same time placed at defined distances.

Combining the packages and generating defined distances are achieved by a plurality of partial conveyor belts of respective conveyor lines. The respective partial conveyor belts are driven by gear motors and are controlled by a frequency converter. The target values for the speeds of respective partial conveyor lines are predefined by a controller. In this case, positions of the packages on the partial conveyor lines are detected using sensors and are processed in the controller. The position between the packages is generally influenced by PI controllers which act between two packages in each case. On the basis of the available information, the partial conveyor lines are accelerated and decelerated differently by the controller.

On account of the plurality of parallel conveyor lines and a plurality of partial conveyor belts in each case, which need to be accelerated and decelerated independently of one another, control is complicated in terms of control engineering. Optimization on the basis of different package sizes and qualities is complex. The adaptation of the control process in the case of different mechanical structures is large. If, for example, the number of conveyor lines or the length of the individual partial conveyor lines is changed, this has a substantial influence on the control process and requires adaptations in the controller.

Determining the optimum speeds of the individual conveyor belts at each point in time and for any situation (number, sizes and positions of the individual packages) is still technically very challenging if there is no physical model (for example simulation) of the installation.

A digital twin in the form of a simulation model that is faithful to physics can be used as a basis for solving this problem. These can be created using digital tools such as NX MCD (Mechatronic Concept Design) from Siemens Digital Industries Software Corp. (formerly Siemens Product Lifecycle Management Software Inc., Siemens PLM Software for short) or Unity Simulation Pro from Unity Software Inc. (trading as Unity Technologies).

A simulation that is faithful to physics and uses NX MCD enables, for example, in addition to modeling in which the geometry is shown, a kinematic assessment of the model in an environment in which physical effects act (for example forces, inertia, accelerations). Validation is supported by the reuse library, from which components can be added to the functional model. The components contain further information, for example geometries, parameters or kinematics. This gradually produces a physics-based, interactive simulation for verifying future machine operation.

It has been recognized that simulations that are faithful to physics can sometimes also cause difficulties and problems:
a) Physics simulations usually require an expert with good knowledge of the system and a construction kit comprising individual parts which have already been simulated (for example different drive motor models). If these are not available, it may become impossible to create these simulations.
b) Simulations that are faithful to physics may sometimes be insufficiently accurate when transferring packages between conveyor belts.
c) The modeling of a complex installation in a manner faithful to physics may be very time-consuming and therefore cost-intensive.
d) If there is a lack of access to the controller of a product, it may likewise be impossible, on account of a lack of knowledge of the details of the controller, to simulate the behavior of the latter with the aid of a simulation that is faithful to physics. This may occur, for example, when the intention is to simulate a competitor's product, to the controller of which there is no access, which may be the case, for example, for a computer-implemented controller when only machine-readable code, rather than its source code, is available and its decompiling is not possible for some reason (for example contractual ban, technical barrier).

### SUMMARY

An aspect relates to producing a digital twin with the aid of neural networks.

In this case, the neural network is connected to existing sensors which are used to capture the actual state of the conveyor belts. In this case, the term “sensor” should be broadly understood and may also comprise currently applied control commands, for example. The input data of the neural network can then comprise the following data, for example:
States of light barriers which are used at particular locations to detect whether a package is currently present
Actual speed of the drive motors of the conveyor belts
Target speed of the drive motors of the conveyor belts, which can be derived, for example, from control commands which are transmitted from a controller to the drive motors.

The task of the neural network is then to predict, on the basis of these data, which values these parameters will presumably have at a particular time in the future.

Further, unexpected technical problems occur when tackling this task. These must first of all be identified and their cause must be figured out. Solutions should then be sought.

For example, neural networks can be trained with a sufficient degree of accuracy only when sufficient training data are available. If only very few training data items are available, the entire state space of a neural network cannot be sufficiently densely covered with training data. This results in neural networks having to interpolate to a very great extent in the intermediate spaces between the training data. Considerable inaccuracies, overfitting and poor generalization may result therefrom.

It has been recognized that a possible solution to this technical problem involves striving for the closest possible temporal clocking of the simulation of approximately 10 ms (or less) in order to generate as many input data items as possible, which are in particular temporally close together, for operation and training.

In this case, the task of the neural network is to predict, on the basis of the input data, which values these parameters will presumably have in the next clock cycle of the close temporal clocking of 10 ms that is strived for.

Surprisingly, it is apparent that neural networks are not able to reliably make the desired predictions on the basis of the above input data if a plurality of partial conveyor lines need to be coordinated with one another.

In this case, the sensors of at least two up to—normally—all partial conveyor lines to be correlated are connected to a neural network and the weights of the neural network are trained with the aid of actual states of the sensors which, as proposed, are captured every 10 ms, for example. In this case, the sensor data at the time t form the input data of the neural network which derives likely sensor data therefrom as output data at the time t+1, wherein the distance between t and t+1 can be selected arbitrarily and, as proposed, can be at a very close 10 ms. These output data are compared with the sensor data actually available at the time t+1.

The degree to which the predictions match reality forms a quality parameter of the neural network, that is to say, for example, distinguishes—like in the case of many other tools in which their precision is important—neural networks which are of a high quality, because they make particularly precise predictions, from neural networks of a lower quality.

While training the neural network, the discrepancies are also used to configure the neural network, usually by adapting its weights.

Another quality parameter which is independent of the precision of the prediction but is no less important, in particular with the proposed close temporal clocking of 10 ms, may be the processing speed of the neural network. As a rough rule of thumb, it is often of secondary importance for a small number of input data items and/or slow processes and can gain considerable importance with increasing complexity.

It is now surprisingly apparent that the neural network with this arrangement and this procedure is not able to reliably create a sufficiently accurate prediction of the likely sensor data at the time t+1 on the basis of the sensor data at the time t.

According to one insight, this is due, inter alia, to a further technical problem of neural networks, whereby it is very difficult for them to handle processes taking place dynamically over time. Neural networks map input data to output data according to their structure and their weights learnt by training. This mapping is fundamentally always the same for identical input data as long as the structure of the network and the weights do not change. It has been recognized that neural networks with a structure described at the outset cannot identify, using the above input data, when in the past a package was collected by a partial conveyor line and how far it has currently already been moved.

The same applies if neural networks are intended to temporally distinguish between a plurality of partial conveyor lines connected in succession and/or in a parallel manner in order to determine which must be accelerated and which must be decelerated so that, for example, a collision of packages transported in a parallel manner at the same height in the combining unit and/or a collision with packages which are decelerated by a downstream partial conveyor line is/are prevented. The situation which is paradoxical for neural networks and in which a particular partial conveyor line sometimes needs to be accelerated, sometimes needs to be decelerated and sometimes needs to be operated without change in the case of identical input data may arise here.

According to one insight, this depends on the situation at superordinate, subordinate or coordinate partial conveyor lines. The slightest differences in the progress of transporting the individual packages are decisive for the controller's decision as to which packages are accelerated, decelerated or transported further without change.

These differences cannot be identified by a neural network when a particular partial conveyor line is considered in isolation. They also cannot be identified by the neural network in the case of an overall consideration of all partial conveyor lines and close clocking of 10 ms. On the basis of its input data, the network only ever sees the respective current state at the time at which the sensor data are sampled. However, the length of time for which this state has already lasted cannot be identified from the captured sensor data.

It is therefore also not readily possible to implement a neural network with Markov properties in which, for the set of successive sensor data captured temporally, for example at an interval of 10 ms, the probability of the next state of the sensor data that is determined by the neural network depends only on the immediately preceding state and not on even earlier states.

Ultimately, this dynamic results in a contradiction with the paradigm that the prediction of a neural network for identical input data is fundamentally always the same as long as the structure of the network and the weights do not change. During training for identical input data, the neural network again and again comes across training specifications which are partly diametrically contradictory. For identical input data of the neural network, identical partial conveyor lines must sometimes be accelerated, sometimes decelerated and sometimes left unchanged. The configuration of the weights then depends on random parameters, for example the sequence or the selection of the training data.

Figuratively speaking, this can be imagined, for instance, as if the internal structure of the neural network begins to “oscillate” during training. It tends randomly—for example depending on how the training data are formed—sometimes in one direction and sometimes in the other direction, possibly even back and forth between different directions.

This diffusivity continues after training has been concluded. Even during operation, constellations in which the predictions of the neural network differ not only slightly, but rather considerably, from the actual behavior of the controller arise again and again.

One task is now to find a solution to the problems identified. This technical task is particularly challenging when close temporal clocking of approximately 10 ms is strived for, since, in this case, information must be transmitted over a large number of time steps, as a result of which the simulation model can become very complex.

In order to solve the time problem, it is proposed, for the package sorting installations used as an application example for the neural networks, to provide, for each sensor which checks the presence of a package, for example by a light barrier, a type of “stopwatch” as a further input data item of the neural network, which stopwatch is always reset to an initial value (usually “zero” in the case of a stopwatch) when the associated sensor indicates a change in its state. This state of this sensor is usually binary in the case of a light barrier, that is to say has precisely two states:
(1) “Light barrier interrupted”=“A package is there at the moment”
(2) “Light barrier not interrupted”=“No package there at the moment”.

Dissociated from this application example, it is recognized that this solution can be reduced to a single sensor in the form of a motion detector and a single stopwatch associated with the sensor. In this case, the stopwatch is reset whenever the sensor detects a movement.

After it has been reset, the stopwatch starts again and measures the passage of time. The value from the stopwatch which is currently applied at each prediction moment is then an indicator of how far in the past the triggering of the sensor was. As a result of this technical teaching, this information can be transmitted over a large number of time steps and a temporal development into the past can be reconstructed for a neural network.

Direct correspondence with a stopwatch can be achieved if a sawtooth curve is applied as an additional input value, which sawtooth curve starts again after each reset and is changed linearly by a constant value in each prediction cycle with the proposed close clocking of 10 ms. In this manner, this temporal information can be transmitted over a large number of time steps with a constant effort. Depending on the configuration of the change value, this results in a linearly rising or falling sawtooth curve. One variant is a curve which is reset to “0” in each case and is changed by “+1” in each cycle.

Alternative configurations in which the stopwatch is changed other than linearly over time are conceivable. It may be modeled, for example, as a rising/falling edge of light barrier signals and not only as a linear, but also as an exponential, sawtooth function. Alternatively, it can be changed on the basis of the differences between a belt position at the time of a falling or rising edge and the current time in each case. Different distances of packages can therefore be identified by the neural network, which is important, in particular, when this aspect is also taken into account by the controller which is intended to be simulated as a digital twin by the neural network.

The stopwatch may likewise be stopped after a certain time has elapsed. In this case, the consideration is that, in the case of the package sorting installation under consideration for example, the controller decides, in particular shortly after a movement has been detected, whether a package is transported further more quickly, more slowly or at the same speed relative to other packages. Once this decision has been made, it usually remains unchanged for the respective transport section until a correction is possibly required as a result of other motion detectors being triggered. However, other stopwatches are then the cause of this situation being detected. Stopping the stopwatch may be considerably advantageous, for example in a large system with a large number of stopwatches, with respect to the processing speed of a neural network and a possibly required real-time capability.

Furthermore, more than one stopwatch may also be provided for a sensor in the form of a motion detector, for example. With regard to package sorting installations, for example, it is advantageous to provide two stopwatches and to start the first stopwatch when a package is detected and to start the second stopwatch when the package has passed the sensor. The size of a package can therefore be identified by a neural network, for example by way of the correlation of the difference between the two watches and possibly the speed of the partial conveyor belt (for example derived from the speed of the gear motor of this partial conveyor belt). This knowledge enables a neural network to simulate, for example, the behavior of a controller which takes into account specifications, for example certain defined distances between packages upstream of a combining unit or upstream of a flow-wrapping machine of a packaging machine.

A digital twin formed using such neural networks can be used, inter alia, for the following purposes and/or can have the following advantages:
Simulating the standard operation of an installation in order to ensure that the specification is complied with;
Determining the throughput of the installation;
Simulating special cases during operation of the installation without investing in special hardware and without causing potential damage to installation components;
Running the simulation model on an edge device in parallel with installation operation and detecting abnormal operating states in the process;
Optimizing the installation structure (for example number of fingers, conveyor belts);
Determining optimum control of the installation using reinforcement learning. For optimum control by reinforcement learning, it is particularly advantageous if a neural network with Markov properties is used for this purpose.
Prediction models based on neural networks may be purely data-based, that is to say do not require any detailed knowledge of the system behavior of drive motors, for example, but rather only data from the past or from structurally identical installations, whereas physical simulation models require exact knowledge of the installation components and their environment. The creation of physical simulation models of complex installations using programs such as NX MCD or Unity therefore generally requires an expert who needs a lot of time in order to model the exact behavior of the installation, whereas a prediction model can be created in an automated manner by training a neural network by supervised learning. This also makes creation more cost-effective because it is possible without experts.
A prediction model created by training a neural network by supervised learning can be retrained at any time if the accuracy of the model is no longer satisfactory.
A prediction model created by training a neural network is based on real data and concomitantly learns transitions at the conveyor belt sections which are difficult to simulate.
If the intention is to change an installation component (for example drive motor) for which there is still no physical simulation model using NX MCD or Unity, for example, a purely data-based prediction model can be created in a considerably faster and therefore more cost-effective manner.
As a result of the use of neural networks, installation components from various manufacturers can be installed and a prediction model can then be created for these components, for which there is no physical simulation model using NX MCD or Unity, for example, and for which no physical simulation model can be created either owing to a lack of access to the manufacturers' data. Optimum controllers can therefore be developed for (rival) installations, for which there are no physical simulation models.
When used on an edge device, a neural network can run in parallel with installation operation and can detect abnormal operating states, for example an incomplete data situation for a prediction model produced by a neural network or a defect of an installation component (for example a drive motor). Alarm data may also be generated if the reality differs greatly from the prediction.
Using recurrent neural networks (RNN) with long short-term memory (LSTM) modules makes it possible to counteract disappearing gradients on account of a very long temporal development (for example a period of 4 seconds corresponds to a temporal development over 400 prediction cycles with clocking of 10 ms).
A high temporal development of an RNN into the past results in a very accurate resolution.
Taking into account conveyor belt lengths makes it possible to obtain a generic model for all installations irrespective of their conveyor belt lengths. This enables a generalization.
A particularly good advantage of neural networks is that conveyor belt transitions which are produced by concatenating two physical individual models tend to result in inaccuracy in physical simulation models, whereas the prediction system learns from training to accurately model these relationships.
Further advantages which are enabled by automatically creating prediction models produced by a neural network are:
   Automated exploration of different installation designs;
   Fast adaptation of the model to new operating modes, installation components or changed situations;
   Transfer learning between different installations.

The neural networks are implemented by a computer program with program code which may be stored, for example, on a non-volatile, machine-readable carrier or in a cloud on the Internet. The computer program implements the above embodiments when the program code is executed on a computer.

### BRIEF DESCRIPTION

Some of the embodiments will be described in detail, with reference to the following figures, wherein like designations denote like members, wherein:

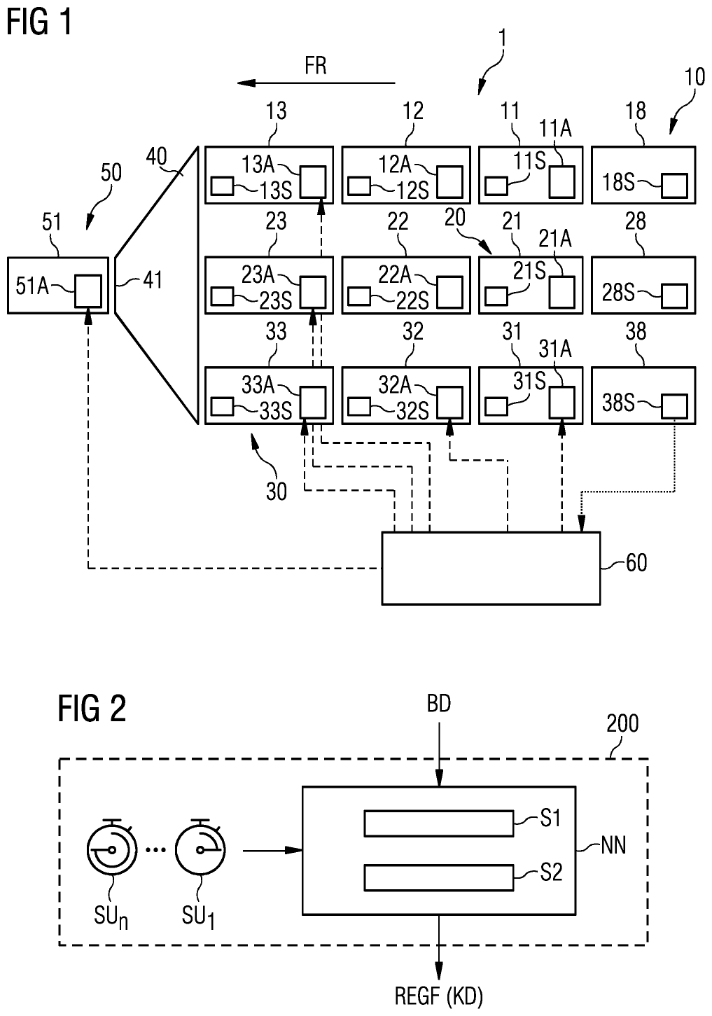

FIG. 1 shows a schematic illustration of a logistics system having a computing unit for carrying out the method according to embodiments of the invention for the computer-implemented configuration of the controlled drive application implemented therein;

FIG. 2 shows a schematic illustration of the method steps carried out by the computing unit;

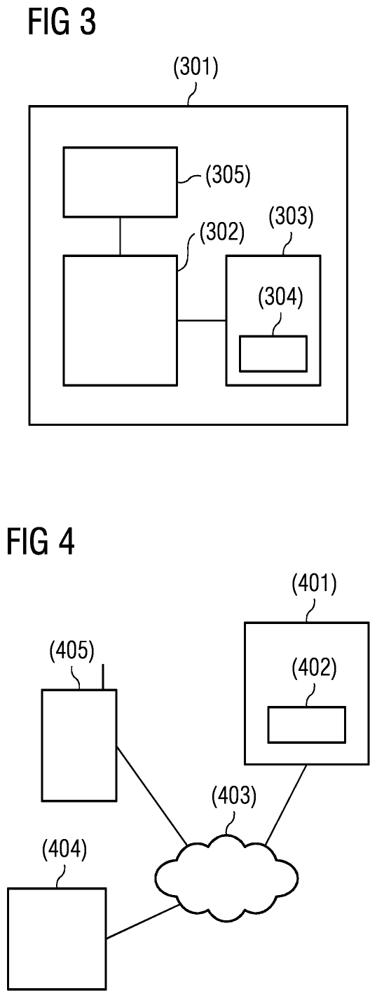

FIG. 3 shows one configuration of the computing unit;

FIG. 4 shows a further configuration of the computing unit;

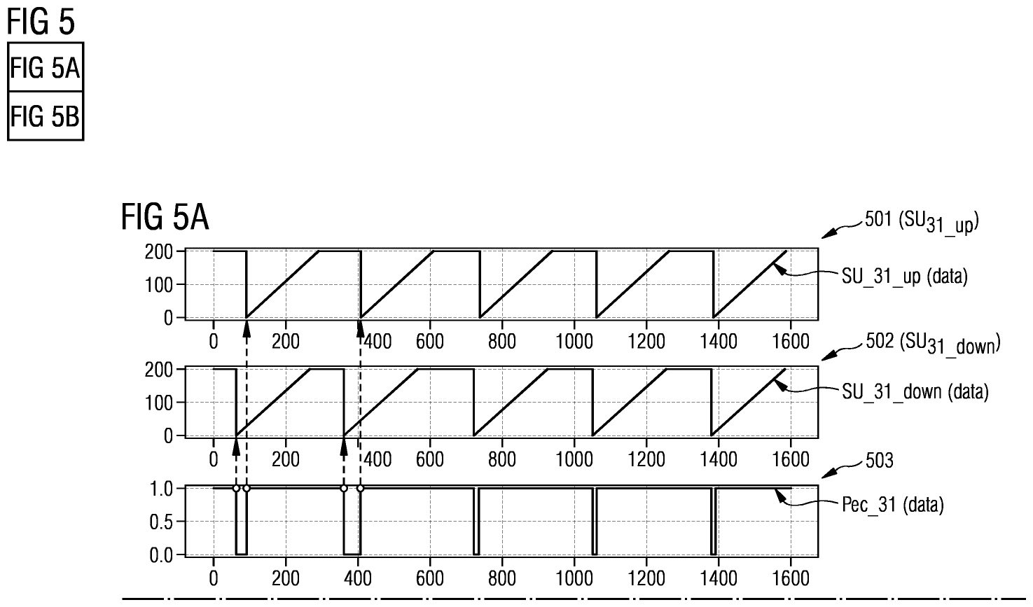

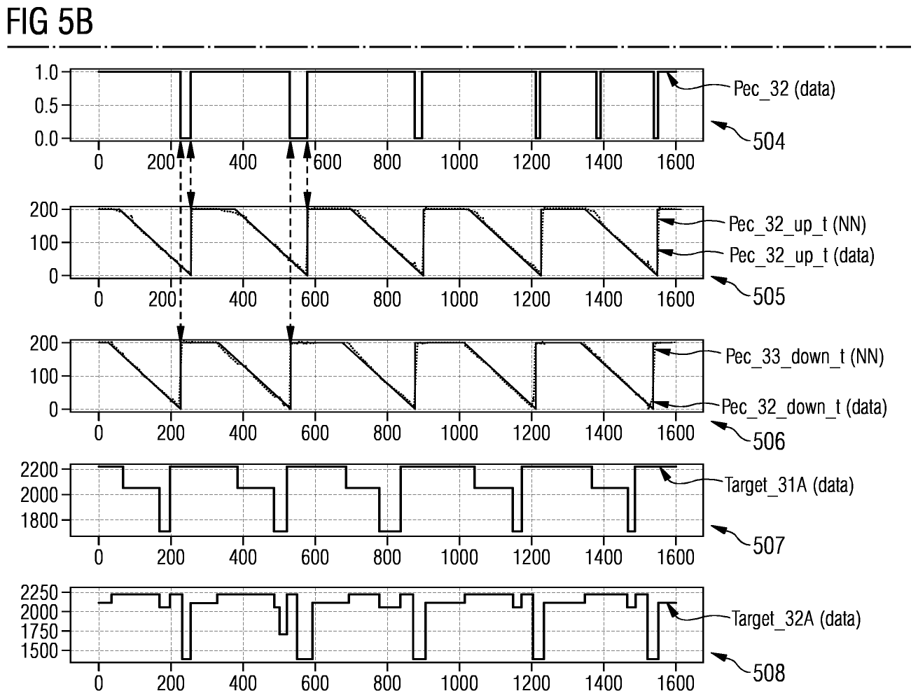

FIG. 5A shows a dynamic behavior of the logistics system and the prediction thereof by a neural network having a plurality of linear stopwatches;

FIG. 5B shows a dynamic behavior of the logistics system and the prediction thereof by a neural network having a plurality of linear stopwatches;

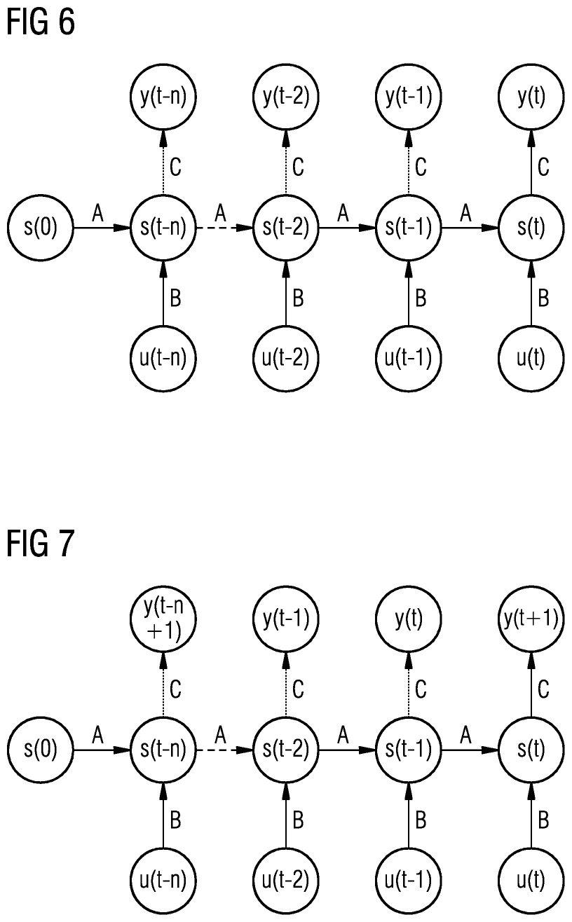

FIG. 6 shows a dynamic behavior of a recurrent neural network;

FIG. 7 shows a dynamic behavior of a further recurrent neural network; and

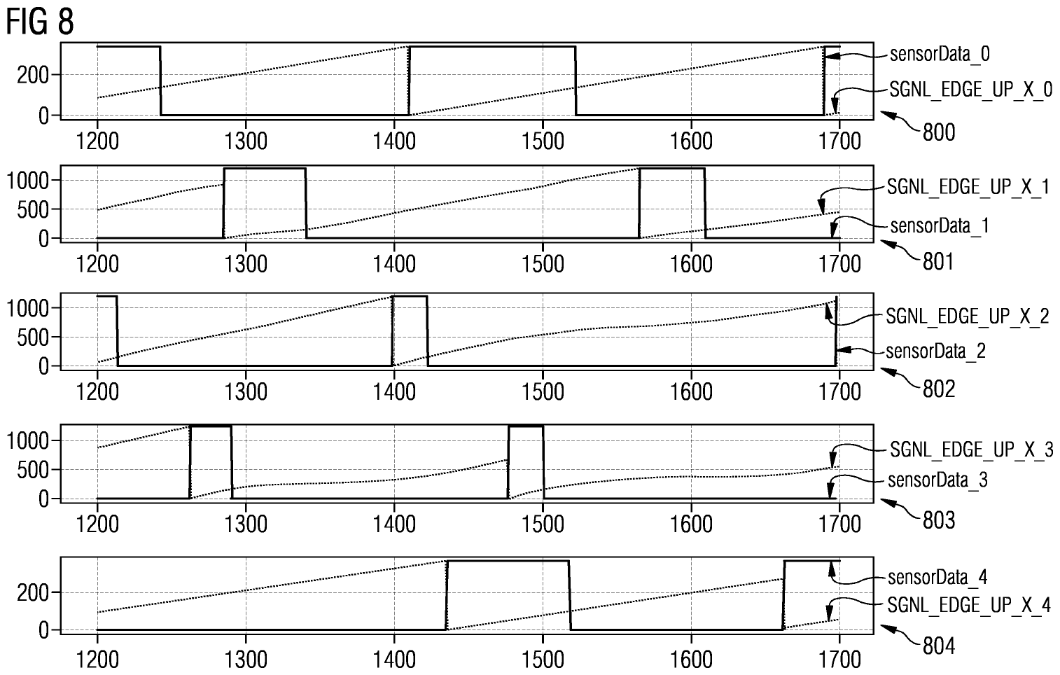

FIG. 8 shows an alternative dynamic behavior of stopwatches for a neural network.

### DETAILED DESCRIPTION

FIG. 1 shows a schematic illustration of a logistics system 1 having a controlled drive application. By way of example, the logistics system 1 comprises three conveyor lines 10, 20, 30 which run parallel to one another and on each of which it is possible to convey piece goods, in particular packages, in a conveying direction FR that runs from right to left. Each of the conveyor lines 10, 20, 30 which are of the same length in this example (but may also be of different lengths) and are also referred to as fingers comprises a plurality of partial conveyor lines 11-13, 21-23, 31-33. The number of partial conveyor lines for each conveyor line 10, 20, 30 is the same in the present exemplary embodiment (but this is also not compulsory and may be different). The partial conveyor lines 11-13, 21-23, 31-33 of a respective conveyor line 10, 20, 30 may also be of the same length or may have different lengths.

Each of the partial conveyor lines 11-13, 21-23, 31-33 has a respective associated drive 11A-13A, 21A-23A, 31A-33A. The partial conveyor lines 11-13, 21-23, 31-33 may be individually accelerated or decelerated by appropriately controlling the drives 11A-13A, 21A-23A, 31A-33A by a computing unit 60.

Arranged at the end of the conveyor lines 10, 20, 30, that is to say in the conveying direction FR, is a combining unit 40, to which the last partial conveyor lines 13, 23, 33 in the conveying direction FR transfer the piece goods that they transport. A single output conveyor line 50 is arranged at an output 41 of the combining unit 40. This may consist of one or more partial conveyor lines 51. The one or more partial conveyor lines 51 are driven by a drive 51A, again under the control of the computing unit 60.

The acceleration and deceleration of respective partial conveyor lines by suitable control signals for the drives 11A-13A, 21A-23A, 31A-33A makes it possible to transport piece goods, which are transported on the parallel conveyor lines 10, 20, 30, to the combining unit 40 with a temporal offset. The combining unit 40 is therefore rendered able to convey the piece goods to the output conveyor line 50 in such a way that two temporally successive piece goods are each at a prescribed defined distance from one another.

In order to enable the computing unit 60 to output suitable control signals for accelerating and decelerating the drives 11A-13A, 21A-23A, 31A-33A, a respective partial conveyor line 11-13, 21-23, 31-33 is provided with a number of respective sensors 11S-13S, 21S-23S, 31S-33S. The sensors 11S-13S, 21S-23S, 31S-33S comprise, in particular, light barriers for determining a respective transport speed, length and/or position of a piece goods item and/or its deviation from an expected position. The sensors optionally comprise, for example, rotational speed sensors detecting the rotational speed of the drives 11A-13A, 21A-23A, 31A-33A, current sensors for detecting the motor currents of the drives 11A-13A, 21A-23A, 31A-33A, etc.

The piece goods are supplied to the conveyor lines 10, 20, 30 via respective transfer units 18, 28, 38 which are likewise in the form of partial conveyor lines, for example. The transfer units 18, 28, 38 also have a corresponding drive (not explicitly illustrated here however) and a number of corresponding sensors 18S, 28S, 38S. The transfer units may be segments which are independent of the actual conveyor lines 10, 20, 30. However, the transfer units 18, 28, 38 may also be a respective partial conveyor line of the associated conveyor line 10, 20, 30.

For the sake of simplicity, only the transfer units 18, 28, 38 are provided with corresponding sensors 18S, 28S, 38S in FIG. 1. Corresponding measurement signals are supplied to the computing unit 60 for further processing. A measurement signal is represented by a dotted line. For the sake of simplicity, not all measurement signals and signal lines required for transmission are illustrated.

The drives 11A-13A, 21A-23A, 31A-33A, 51A associated with the partial conveyor lines 11-13, 21-23, 31-33 are controlled with corresponding control signals via dashed lines. For the sake of simplicity, not all control signals and control lines required for transmission are illustrated.

The computer-implemented configuration of the controlled drive application of the logistics system 1 is carried out by the computing unit 60 in FIG. 1. However, the steps may also be carried out on a computing unit which is independent of the ultimate control of the logistics system 1.

The control logic of this control that is carried out by the computing unit 60 may also be learnt and then predicted/simulated by a system 200 which is schematically illustrated in FIG. 2 and comprises at least one neural network NN and at least one stopwatch SU. This procedure is schematically illustrated in FIG. 2.

In a first step S1, a system model of the logistics system 1 is determined on the basis of operating data BD of the logistics system. The operating data BD are available for a multiplicity of times in the operation of the logistics system 1 and comprise, for each time, measured values from the sensors 11S-13S, 21S-23S, 31S-33S, 18S-38S, for example light barrier signals, motor currents, positions of the piece goods on the respective partial conveyor lines 11-13, 21-23, 31-33, 18-38, rotational speeds of the drives 11A-13A, 21A-23A, 31A-33A, and speeds of the partial conveyor lines 11-13, 21-23, 31-33. In principle, not only operating data BD of the logistics system 1 currently being considered, but also operating data BD of other logistics systems which are then similar, can be processed in this case.

In addition, manipulated variable changes, which comprise, for example, speed changes or rotational speed changes of the drives 11A-13A, 21A-23A, 31A-33A, 18A-38A, are determined and processed for each time in step S1.

At least one stopwatch SU is also used in step S1. This is reset to an initial value whenever the value changes an associated operating data item BD in a particular manner (for example from “0” or “1” or vice versa). This operating data item BD is one of the measured values from the sensors 11S-13S, 21S-23S, 31S-33S, 18S-38S, in particular a light barrier signal for determining the position of the piece goods on the respective partial conveyor lines 11-13, 21-23, 31-33. Stopwatches SU may be provided for a plurality of or even for all light barriers. The number of stopwatches SU provided for each operating data item BD is also variable. This flexibility in the use of the stopwatches SU is represented by indices 1 . . . n on the reference sign SU. These indices are omitted if reference is not made to a particular stopwatch. The general reference sign SU should fundamentally not be understood as being restrictive to a single stopwatch, specifically not when only the behavior of one specific stopwatch is described for the purpose of simplification.

In this case, it is clear to a person skilled in the art that the stopwatches in the context of this computer-implemented technical teaching are in the form of computer-implemented, digital stopwatches. They are applied to the neural network NN in addition to sensor data from the logistics system and are reset to an initial value, for example, whenever motion detectors indicate the passage of a package.

The system model is determined with the aid of at least one—recurrent—neural network NN. In this case, it is clear to a person skilled in the conventional art that this technical term in this technical field is used to denote computer-implemented, artificial neural networks NN.

In order to determine the system model, the neural network NN is configured by training/learning and, in particular, by supervised learning methods, wherein the stopwatches SU are supplied to the neural network NN as (additional) input data in addition to the operating data BD. Since the relevant procedure is known (also see, inter alia, the statements made with respect to the training of neural networks at the beginning of the description), a repeated description is dispensed with at this point. As a result, this training results in a correlation between the operating data BD and the respective progression of the stopwatches SU being additionally stored in the weights of the neural network NN which has been configured and structured in this manner.

This procedure has particularly good effects in the case of input data which are identical at a given time without stopwatches SU, but differ in the temporal context of the preceding input data. This temporal development of the past behavior of the simultaneously running partial conveyor lines 11-13, 21-23, 31-33, 18-38 is highly relevant to the control behavior of the computing unit 60 and decisively determines which of the partial conveyor lines 11-13, 21-23, 31-33, 18-38 should be accelerated, decelerated and operated further with an unchanged speed.

As a result of the additional input of stopwatches SU, input data which would be identical without stopwatches SU now differ as a result of different combinations of current values from the stopwatches SU. This avoids the “oscillation” of the training and of the predictions of the trained neural network NN, as described at the outset.

In a second step S2, a likely control function REGF of the logistics system 1 is determined by the system 200. The control function REGF comprises, for example, configuration data KD for the drives 11A-13A, 21A-23A, 31A-33A, that is to say motor currents and/or rotational speeds and the like, with the result that the associated partial conveyor lines 11-13, 21-23, 31-33 can be accelerated or decelerated in a suitable manner. All or some of these configuration data KD can now be predicted by the system 200. It is likewise conceivable to train and/or configure the system 200 such that it predicts when a package in the conveying direction FR reaches (prediction 1) and/or completely passes (prediction 2) a next light barrier. These values can be output as falling sawtooth curves, for example. In this case, the progress of the individual steps is determined by the frequency with which the predictions are made by the system 200. In the case of clocking of ms, as proposed at the outset, such a step function would have 100 steps, for example, for a period of 1 sec.

The determination of the control function REGF on the basis of the system model configured in step S1 can be used very universally by predicting at least likely control while specifying one or more goals to be achieved in the system model. One or more of the following parameters may be taken into account, for example, as a goal: an average throughput of piece goods at the output 41 of the combining unit 40; a distance, in particular a minimum distance, between two piece goods items conveyed in direct succession, that is to say a gap distance; the detection of a collision in the combining unit 40, in particular at its output 41; a distance uniformity measure that characterizes a deviation of the distances from an equidistance between in each case two piece goods items conveyed in direct succession, that is to say a uniformity of the gap distance; and a running speed of the three conveyor lines of a respective conveyor line or of all of the conveyor lines in order to achieve wear optimization, for example.

In this case, practical distributions over previously available operating data BD can be produced by varying typical model input variables, for example sizes of the piece goods, their mass, coefficients of friction and the like. This enables a high degree of robustness of the derived predicted control function REGF and configuration data KD.

FIG. 3 shows an example of a computer implementation of the technical teachings described here, which implementation comprises the following:
(301) Computer system
(302) Processor
(303) Memory
(304) Computer program (product)
(305) User interface

In this embodiment, a computer program product (non-transitory computer readable storage medium having instructions, which when executed by a processor, perform actions) 304 comprises program instructions for carrying out the invention. The computer program 304 is stored in the memory 303, which, inter alia, makes the memory and/or the associated computer system 301 a provision apparatus for the computer program product 304. The system 301 can carry out embodiments of the invention by executing the program instructions of the computer program 304 by the processor 302. Results of embodiments of the invention can be displayed on the user interface 305. Alternatively, they may be stored in the memory 303 or in another suitable means for storing data.

FIG. 4 shows a further exemplary embodiment of a computer implementation comprising:
(401) Provision apparatus
(402) Computer program (product)
(403) Computer network/Internet
(404) Computer system
(405) Mobile device/smartphone

In this embodiment, the provision apparatus 401 stores a computer program 402 which contains program instructions for carrying out the invention. The provision apparatus 401 provides the computer program 402 via a computer network/Internet 403. For example, a computer system 404 or a mobile device/smartphone 405 can load the computer program 402 and can carry out embodiments of the invention by executing the program instructions of the computer program 402.

FIGS. 5A and 5B illustratively shows, using the example of the two partial conveyor lines 31 and 32 arranged in succession in the conveying direction FR in FIG. 1, the predictions of a system 200, the neural network NN of which has the goal of predicting when a package, after passing a first light barrier 31S, reaches (prediction 1) and completely passes (prediction 2) a second light barrier 32S. In this example, the two values are output as falling sawtooth curves.

In this minimal embodiment, data from the two conveyor belt sections 31, 32 connected in succession are illustrated. One goal is to predict a rising/falling edge of the light barrier 32S of the conveyor belt 32 downstream of the conveyor belt 31 on the basis of the rising/falling edges of the light barrier 31S of the incoming conveyor belt 31. In this case, a light barrier provides a binary signal, where “0”=no package passes the light barrier and “1”=a package passes the light barrier. The goal is to generate a rising/falling edge Pec_32_up_t (NN), Pec_32_down_t (NN) which, for each point in time t, describes the time to the next changeover time (from 0 to 1 or from 1 to 0).

The simulation model (also called prediction model) implemented by the neural network NN is initially trained in this embodiment with historical data relating to the installations to be optimized or comparable installations using supervised learning. The prerequisites for training prediction models are in this example:
The light barriers 31S, 32S at the start of a conveyor belt are always installed at the same position. This may be relevant, for example, when different conveyor belt lengths are intended to be simulated as part of design optimization.
The lengths of the partial conveyor belts 11-13, 21-23, 31-33, 18-38 are known and are supplied to the prediction model as part of the input data. This has the advantage that the model can handle different conveyor belt lengths and can even interpolate between different known conveyor belt lengths.

An entire installation can also be simulated in a similar manner, that is to say the behavior of the light barriers of a plurality of downstream conveyor belts or conveyor belt arms running in a parallel manner. The statements in this example are pars pro toto.

Very small time steps with (t+1)−t≈10 ms are simulated. This requires a high degree of temporal development into the past for the prediction model in order to be able to determine the time of the rising/falling edges of the downstream light barrier 32S as precisely as possible on the basis of the rising/falling edges of the incoming light barrier 31S on account of packages passing through. For this purpose, n=400 steps from the past are used, for example; this corresponds to 4 seconds of real interaction time on the conveyor belts 31S, 32S.

The graphs 501-508 partially illustrate some parameters from the real operation of an installation corresponding to that in FIG. 1 over a period of slightly more than 16 seconds. This period is respectively plotted on the x axis with a scale in milliseconds.

In these 16 seconds, four packages are transported completely (plus two further packages in part at the beginning and end) on the two conveyor belts 31S, 32S. The curve Pec_31 (data) in graph 503 shows the passage of the packages through the light barrier 31S and the curve Pec_32 (data) in graph 504 shows the delayed passage of the same packages through the light barrier 32S. Two adjacent state changes each of a light barrier 31S, 32S from “1” to “0” (current package past) and from “0” back to “1” (subsequent package identified) are produced by a gap between two successive packages. It can easily be seen that the gaps have variable sizes in this example and are approximately in the range of 0.1-0.5 seconds, whereas the dwell time of the packages on the conveyor belts 31, 32 is considerably longer and is in the range of a rough estimate of approximately 2.5-3.5 seconds. Each package therefore stays for less than 4 seconds on one of the conveyor belts 31, 32, with the result that, in this example, a past of n=400 steps is sufficient to cover the complete passage of a package on each of the conveyor belts 31, 32. Nevertheless, the past also need not be selected to be (even) greater, however.

In the graphs 507, 508, the two curves Target_31A (data), Target_32A (data) show the manipulated variables for the speed and rotational speed of the two drives 31A, 32A of the two conveyor belts 31, 32, which manipulated variables are output by the computing unit 60. These manipulated variables are aimed at achieving, by accelerating and decelerating packages, the predefined control goals, that is to say, for example, preventing collisions in the combining unit or optimally using the conveying capacity by minimizing the distance between the packages or having a distance such that the packages transported by the installation 1 are delivered in a manner matching the clock frequency of a flow-wrapping machine (not illustrated) at the end of the conveyor line.

Correlating the interval of time between the two adjacent state changes of a light barrier 31S, 32S from “1” or “0” (current package past) and from “0” back to “1” (subsequent package identified) with the manipulated variables of the respectively associated drives 31A, 32A makes it possible to fairly accurately derive the horizontal distance between the packages passing through, which is important information for achieving ideal distances between packages. Applying this information as input data to the neural network NN therefore means that the neural network NN is also able to internalize the correlation in its weights by virtue of the training in step Si and to then derive therefrom a prediction of the future behavior of a controller from given input data in step S2, which prediction also reliably takes into account the horizontal distance between the packages.

The horizontal size of the packages can also be derived in a comparable manner. The important factor here is the interval of time between the two adjacent state changes of a light barrier 31S, 32S from “0” to “1” (current package identified) and from “1” back to “0” (current package past). However, this correlation is more complex because it extends over a considerably longer period and a plurality of different speeds of the drives 31A, 32A fall into these periods. On account of the considerably longer extend into the past—in comparison with the distance between packages—the horizontal size of a package is more difficult for the neural network NN to learn and identify than the distance between two packages.

The prediction model from the system 200 can handle challenges like these and other challenges by using at the time t—restricted to the two conveyor belts 31, 32 in the example for the sake of easier comprehensibility—the following input features as input data of the neural network NN, measured for the last n time steps:
Length of the conveyor belt sections 31, 32
Light barrier state Pec_31 (data), Pec_32 (data)
Time of the last light barrier state change as a temporally rising sawtooth curve (represented in the graphs 501, 502 by the respective current value of two stopwatches SU_{31_up}, SU_{31_down}, wherein a first stopwatch SU_{31_up} is reset to an initial value “0” in the case of a falling edge of the curve Pec_31 (data), which indicates the entry of a package into the light barrier 31S, and a second stopwatch SU_{31_down} is reset to an initial value “0” in the case of a rising edge of the curve Pec_31 (data), which indicates the exit of a package from the light barrier 31S). In this case, this need not necessarily be a piecewise linear function such as a sawtooth curve, but rather may also be an exponential function, for example. The resetting of the associated stopwatches SU to an initial value, which is triggered by a light barrier state change, is indicated in FIG. 5A by exemplary arrows between the graphs 501 and 502, wherein the arrows start from graph 502 and have their effect in graph 501 by virtue of the stopwatches SU illustrated there being reset to an initial value “0” in this example.
Actual and/or target speed of the drive motors 31A, 32A (in the graphs 507, 508, the target speed is illustrated in the curves “Target_31A (data)”/“Target_32A (data)”).

FIG. 6 and FIG. 7 show different variants of a possible prediction model with neural networks NN. Here, in each case for a specific time t:
s(t) indicates the current state of the installation 1
u(t) indicates the input data of the system 200
y(t)indicates the output data of the system 200.

In this case, using the example of the partial conveyor line 31, the input data in the two variants illustrated at the time t may be pars pro toto:
Length of the partial conveyor line 31
State of the light barrier 31
Value of the stopwatches SU_{31_up}, SU_{31_down}
Actual speed of the drives 31A, 32A
Target speed of the drives 31A, 32A.

For the implementation of a prediction model, the recurrent neural networks NN known from the literature are very highly suitable since they have the property of being able to inherently represent temporal relationships. This has the advantage, in particular, that the time behavior of the underlying dynamic system, for example the installation 1, can be learned using a single matrix A, and the state s(t) at the respective time t is comparatively small. In the case of a large number of time steps from the past to be taken into account, for example n=400 in this case, this matrix would be very large in the case of standard MLPs (multi-layer perceptrons) and therefore susceptible to overfitting. The matrices A/B/C in the two variants illustrated are each “shared” weight matrices, so-called shared weights, which are trained by backpropagation through time (BPTT), for example, by using the average value of all n error gradients for a gradient descent step.

The variant illustrated in FIG. 6 shows a recurrent neural network NN which has the goal of predicting the number of time steps measured after the time t, after which a rising/falling edge of the light barrier 32 of the downstream conveyor belt 32 can be expected, as output data of the system 200 at the time t (for example as a countdown timer).

It tackles this task with the following state transition equations and pursuing the following optimization goal:

State transition equations:

yₜ=Csₜ (1)

sₜ=tanh(Buₜ+Asₜ₋₁) (2)

Optimization goal:

$$\frac{1}{n} {\sum }_{k = 0}^{k = n} {( {y}_{t - k} - {y}_{t - k}^{d} )}^{2} \to {min}_{A , B , C} \qquad ( 3 )$$

The temporal profile of the output data produced in this manner is illustrated in FIG. 5B in graph 506 as the curve Pec32_down_t (NN) for the falling edge and in graph 505 as the curve Pec32_up_t (NN) for the rising edge. By superimposing actually measured data on the two prediction curves, it is seen that the predictions at each time t correspond almost exactly to the curves representing reality— Pec_32_up_t (data) in graph 505 and Pec_32_down_t (data) in graph 506. Arrows between the graphs 504 and 505 are used to illustrate by way of example in FIG. 5B that the actual occurrence of the edges is very accurately predicted by the neural network NN.

With this variant, the likely behavior of the downstream light barrier 32 can be predicted with only one step over a long-time horizon, as a result of which many calculation (intermediate) steps are dispensed with in the computer implementation. This is of particularly good advantage if, for example, the control commands for the drives (target speed of the drive motor) are intended to be optimized over a large number of steps in order to avoid, for example, an imminent collision in good time during the package separating process on the outgoing conveyor belt (considered over a plurality of arms).

However, no single-step dynamic of the actual speed of drive motors can be achieved in this manner. The “single-step dynamic” is used to mean that the subsequent state at the time t+1 is dependent only on the state and the input data BD at the time t (Markov property).

The variant illustrated in FIG. 7 shows a recurrent neural network NN which can achieve such a single-step dynamic at the time t. It has the goal of predicting the following output data:
the likely expected binary state of the light barrier 32 of the downstream conveyor belt at the time t+1 and
the likely expected actual speed of the drive motors 31A, 32A at the time t+1 on the basis of their target speeds up to the time t.

It tackles this task with the following state transition equations and pursuing the following optimization goal:

State transition equations:

yₜ₊₁=Csₜ (1)

sₜ=tanh(buₜ+Asₜ₋₁) (2)

Optimization goal:

$$\frac{1}{n} {\sum }_{k = 0}^{k = n} {( {y}_{t - k} - {y}_{t - k}^{d} )}^{2} \to {min}_{A , B , C} \qquad ( 3 )$$

With this variant, in addition to the likely states of downstream light barriers, it is also possible to simulate the likely actual speeds of the drive motors at the time t+1 (inertia of the drive).

A particularly good advantage is that the output at the time t can serve the neural network NN directly as an input at the time t+1, as a result of which a step-by-step dynamic can be simulated over theoretically any number of steps into the future. This makes it possible, inter alia, to track packages on the conveyor belt.

In the comparison of the two variants, a computer implementation of the variant illustrated in FIG. 6 is possibly somewhat less computing-intensive because, in the variant illustrated in FIG. 7, each calculation step is individually simulated, with the inclusion of the target speed to be effected.

FIG. 8 shows alternative configurations of digital stopwatches SU. In this example, the five curves SGNL_EDGE_UP_X_0 to SGNL_EDGE_UP_X_4 in the graphs 800-804 show the dynamic profile of five digital stopwatches SU on the basis of rising/falling edges of light barriers associated with them. The curves of the digital stopwatches SU are achieved in this example using the sawtooth functions which do not increase linearly over time, but rather on the basis of the differences between the belt positions
at the time of the falling or rising edge of light barriers associated with them and
at the current time.

For the purpose of simplification, only the curves for stopwatches SU which are reset to an initial value in the case of a rising edge of a light barrier are illustrated in the graphs 800-804. Similar curves (not illustrated) may also be provided for stopwatches SU which are reset to an initial value in the case of a falling edge of a light barrier.

In this example, the curves for the stopwatches SU show, at each time 1200-1700, the accumulated movement of the conveyor belts, measured in [mm], since the last rising light barrier edge in the curves sensorData_0 to sensorData_4.

In this case, the conveyor belts represented in the graphs 800 to 804 are moved at a constant speed, which is why linearly rising curves result for the two curves SGNL_EDGE_UP_X_0 and SGNL_EDGE_UP_X_4.

In contrast, the conveyor belts represented in the graphs 801 to 803 are moved at variable speeds, as a result of which the non-linear, monotonously rising behavior of the curves SGNL_EDGE_UP_X_1 to SGNL_EDGE_UP_X_3 results in this example.

Although the above considerations were illustrated and described in part in a very detailed manner, in particular using the example of the highly complex, time-dependent correlation between partial conveyor belts of a complex package conveying installation having a plurality of parallel conveyor belts, they are not restricted by the disclosed examples and other variations can be derived therefrom by a person skilled in the conventional art without departing, in particular, from the scope of protection of embodiments of the invention defined by the claims. Many of the considerations thus likewise apply in any system, the dynamic behavior of which can be described with the aid of at least one series of measured values of measurable system parameters which are gathered in a distributed manner over a period. Many dynamic systems which interact with the environment comply with this prerequisite. Without any claim to completeness, a dynamic system may be, for example, a mechanical structure, an electrical network, a machine, a conveying or sorting installation for any desired objects, for example suitcases, letters or materials, a production line, as used, for example, in the production of automobiles, a metering installation known from process engineering or a biological process. The dynamic behavior of control engineering systems can also be measured and thus predicted by embodiments of the invention. Other applications and fields of application of embodiments of the invention can be derived from these application examples by a person skilled in the conventional art without departing from the scope of protection of embodiments of the invention.

This large universal range of applications is explained, inter alia, by the fact that the technical teaching for solving a technical problem is completed with the provision of the innovative neural networks NN, if not even earlier solely by the arrangement and functional operative connection of the neural networks NN. For the complete implementation of the technical teaching, a specific application to a specific system, which can involve, for example, influencing the system by generating, outputting and/or applying a control signal to the system, is not absolutely necessary. Such a downstream application to a system is possible, but optional. For a complete implementation, there is likewise no need for a direct connection to sensors which are used to collect measured values directly during operation of a system. The measured values may also be collected at an earlier time or may have been artificially generated because there was a desire to investigate the behavior of a hypothetical system which is only planned but has not yet been produced, for example. It is clear that considerable savings of valuable resources can be achieved by avoiding prototypes.

It is also insignificant and irrelevant whether control signals generated by neural networks NN are applied to the system automatically by a machine control apparatus or manually by an intervention of a person, because this is only a step which is downstream of the technical teaching and, depending on the embodiment, may constitute an independent technical teaching per se or in interaction with the—in this sense upstream—neural network NN. Such an application of a neural network NN to a system may involve directly influencing a package sorting installation, for example. However, many other identical processes influencing systems in reliance on the innovative neural networks NN and the predictions and control signals created by them are possible and can be carried out automatically by machine or manually by appropriately instructed people. To name a few selected examples of many others, these may be, as described in detail, a process influencing the speed of transport belts of a package sorting installation in order to counteract a predicted future bottleneck; on a production line for automobiles, it is possible to react to future shortages of components in good time in order to counteract a production stoppage; in a biological process, this may be a change of ingredients in order to counteract a predicted future development, which is considered to be disadvantageous, early and, in particular, in a timely manner. Like in many dynamic systems, this temporal component is particularly important on account of the inherent latency with which the system reacts to changes in system parameters, in particular when disadvantageous developments can be counteracted only preventatively because a correction is no longer possible if damage has already occurred.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A neural network for managing processes with temporal development into the past using input data, which describe a state of the process, and output data derived therefrom by the neural network, wherein at least one digital stopwatch is provided,
a. the value of which is supplied to the neural network as a further input data item, and
b. which is set to an initial value in the event of a specific change in one of the input data items and then indicates to the neural network an increasing distance from this time with a rising or falling profile of its value.

2. The neural network as claimed in claim 1, wherein the profile of the value of the stopwatch rises or falls
a. linearly,
b. exponentially, or
c. on the basis of differences between the value of at least one of the input data items at the time at which the stopwatch was last reset to its initial value and the values of these input data at the subsequent times.

3. The neural network as claimed in claim 1, wherein the stopwatch is stopped after a certain time has elapsed.

4. The neural network as claimed in claim 1, wherein at least one input data item is a state of a light barrier which, within the scope of the temporally developed process, alternately indicates the presence and absence of piece goods passing by the light barrier with the aid of binary values, and two stopwatches (SU_{31_up}, SU_{31_down}) are provided for this input data item, one of which is reset when the beginning of the presence is indicated by a change in the binary value and the other of which is reset when the beginning of the absence is indicated by a change in the binary value.

5. A method for configuring a neural network configured as claimed in claim 1, in which the configuration is effected by data-based training of the network with the aid of input data for the process from the past.

6. A neural network trained according to claim 5.

7. The use of a neural network configured as claimed in claim 1 to predict at least one likely future behavior of an industrial installation in which at least two processes take place at the same time in a relative dependence on one another and are at least partially controlled relative to one another on the basis of their temporal development into the past.

8. A computer program product or non-transitory computer readable storage medium having instructions, which when executed by a processor implements a neural network as claimed in claim 1 when the computer program product is executed by a computer.

9. A computing unit comprising a computer program product as claimed in claim 8.

10. A logistics system having one or more parallel conveyor lines for piece goods, which each lead to a combining unit in the conveying direction, wherein each of the conveyor lines includes a plurality of partial conveyor lines which are accelerated or decelerated by a respectively associated drive under the control of a computing unit configured as claimed in claim 9 in order to enable the combining unit to combine the piece goods onto a single output conveyor line at a defined distance.
